(19) United States
(12) Patent Application Publication
(10) Pub. No.: US 2024/0176924 A1
(43) Pub. Date: May 30, 2024

(54) METHOD AND SYSTEM FOR BRACKET CONFIGURATION

(71) Applicant: MAFI AB, Mora (CH)

(72) Inventor: Nigel John Topp, St-Légier-La Chiésaz (CH)

(21) Appl. No.: 18/282,729

(22) PCT Filed: Mar. 18, 2022
(86) PCT No.: PCT/EP2022/057129

§ 371 Date: Sep. 18, 2023

(30) Foreign Application Priority Data
Mar. 19, 2021 (SE) 2150321-4

(51) Int. Cl. G06F 30/17

(52) U.S. Cl. CPC G06F 30/17

(57) ABSTRACT

The present invention relates to a computer implemented method for bracket configuration recommendation for a user-selected piece of equipment used for sending or receiving electromagnetic radiation, wherein said piece of equipment is to be subjected to wind pressure, said method comprising: obtaining information and using this to determine a predicted peak force which said piece of equipment is to be subjected to, based on determined drag coefficients and determined peak wind pressures from each one of a number of directions; assigning a score to each one of a plurality of bracket configurations based on their structural properties in relation to the predicted peak force determined; and generating, at an output, a signal indicative of a bracket configuration recommendation based on said score.

### FIELD OF THE INVENTION

The present invention relates to a method for generation of GIS-based equipment-support modular steelwork kit configuration recommendations.

### BACKGROUND OF THE INVENTION

When installing antennas, radios, cameras or other pieces of equipment for sending or receiving electromagnetic radiation, a connection between the equipment and a base structure is needed. The base structure may for example be a tower or a foundation, to which the equipment is connected by means of at least one equipment-support modular steelwork kit. In certain cases, the connection between the antenna or other piece of equipment and the base structure is additionally provided by means of an offset pole used to define the positioning of the equipment relative to the base structure. Depending on the characteristics of the equipment, the predicted wind pressure on the site of installation and the length of the offset pole, different types of brackets may be needed.

The legal requirement that structural steelwork kits should be CE-marked was introduced in the EU in July 2014. This legislation requires that suppliers and/or users of structural steelwork kits provide calculations to prove that the specified products are fit for purpose. Performing these calculations is often difficult, and requires the consideration of a great many parameters.

Today, buyers of telecom steelwork frequently provide specifications without structural calculations. Suppliers then design steelwork to meet the requirements of the buyer using readily available structural sections, such as channels and angles. This leads to structural steelwork kits made from components that are oversized relative to their application and purpose, which increases the total weight of the steelwork. This weight increase, in turn, increases the maximum force that the steelwork need to support.

Thus, suppliers of structural steelwork kits e.g. for telecom applications of today, using traditional design methods, are not able to provide the most efficient solution to the needs of the application.

As such, there is a need for a method for accurate calculation of structural steelwork requirements, i.e. predicted force application on the piece of equipment to be mounted, and for determining an efficient solution to a structural steelwork need.

### SUMMARY OF THE INVENTION

It is an object of the present invention to alleviate at least some of the mentioned drawbacks of the prior art and to provide a method for generation of GIS-based equipment-support modular steelwork kit configuration recommendations. This and other objects, which will become apparent in the following, are accomplished by a computer implemented method and a system as defined in the accompanying independent claims.

The term exemplary should in this application be understood as serving as an example, instance or illustration.

The present invention is at least partially based on the realisation that calculating which equipment-support modular steelwork kit configuration to use for a given piece of equipment at a given GPS position is time-consuming and complex. In the following, equipment-support modular steelwork kits will interchangibly be referred to as brackets or bracket configurations. Being able to generate recommendations on bracket configurations adaptively, based on local conditions at a chosen GPS position for equipment placement and based on the characteristics of the piece of equipment to be mounted is something that would not be possible for the skilled person to do using manual methods. Thus, the present invention provides a computer implemented method for generation of GIS-based equipment-support modular steelwork kit configuration recommendations, and for bracket configuration for a user-selected piece of equipment used for sending or receiving electromagnetic radiation.

This is beneficial, as bracket configurations that are chosen based on a bracket configuration recommendation generated by a method according to the present invention are easier to handle due to their lighter weight, are quicker to install due to the possibility of automatic generation of installation guides, are easier to transport due to their smaller dimensions, and require less material to produce. Thus, a method providing a user with information indicative of a bracket configuration recommendation is beneficial.

In the context of the present invention, the equipment may be e.g. solar panels, or equipment used in signal transmission such as antennas.

According to the first aspect of the present invention, a computer implemented method for bracket configuration for a user-selected piece of equipment used for sending or receiving electromagnetic radiation is provided, wherein said piece of equipment is to be subjected to wind pressure. The method comprises obtaining a GPS position and an elevation for intended equipment placement by means of a user interacting with a graphical user interface of a computer implemented map module; obtaining equipment information indicative of the shape and size of the piece of equipment and calculating drag coefficients thereof; obtaining GIS information associated with an area surrounding said GPS position and determining a set of first peak wind pressure factors therefrom; determining peak wind pressure from each one of a plurality of directions at the chosen elevation at said GPS position based on said set of first wind pressure factors; determining a predicted peak force which said piece of equipment is to be subjected to, based on said drag coefficients and said peak wind pressures from each one of said directions; assigning a score to each one of a plurality of bracket configurations based on their structural properties in relation to the predicted peak force determined; and generating, at an output, a signal indicative of a bracket configuration recommendation based on said score.

According to one aspect of the present invention, said computer implemented method is a computer implemented method for bracket configuration recommendation for a user-selected piece of equipment used when sending or receiving electromagnetic radiation.

As such, the method of the present invention relates to a method for GIS-based bracket configuration, which is used to generate a suggestion on suitable bracket configurations based on predicted force applications from wind pressure and equipment weight.

In the context of the present invention, the peak wind pressure is a predicted peak wind pressure determined by taking into account at least a set of first wind pressure factors.

The predicted peak force is determined by calculating and combining force components from weight of the equipment and wind pressure-induced drag, or drag force, acting on the equipment.

The determination of predicted peak force involves determining the maximum drag which said piece of equipment is to be subjected to from each one of said directions, based on said drag coefficients and said peak wind pressures.

Drag is the force applied to an object having relative motion to a fluid, such as a piece of equipment subjected to wind. The drag is calculated using a formula involving the cross-sectional area of the equipment measured perpendicular to the relative fluid motion, a drag coefficient of the piece of equipment in the direction of the relative fluid motion, and the speed of the fluid relative to the piece of equipment. Alternatively, drag may be referred to as drag force.

According to one example embodiment, drag is the horizontal component of the force that the equipment is to be subjected to as a result of the wind pressure. Additionally, a vertical component of the wind pressure induced force may be determined based on the GIS information and the equipment information. The drag may then include also the vertical component of the force.

In the context of the present invention, the maximum drag is an estimation of the peak force applied to the piece of equipment as a result of wind pressure applied thereon from said plurality of directions.

The scoring assigns a score to each bracket configuration, wherein the score is indicative of the relationship between the strength of the bracket configuration and the peak force predicted that the piece of equipment will be subjected to for each one of said directions.

According to one example embodiment, a bracket configuration that is able to withstand the predicted peak force from each one of said directions is scored higher than one that is not able to withstand the force from all of said directions. Furthermore, two bracket configurations that both are able to withstand the predicted peak force from said directions may be scored such that the bracket configuration that has the lowest overcapacity in relation to a predetermined safety margin is scored higher than that which has a larger safety margin.

According to one example embodiment, different scoring factors may be used when assigning scores to the different bracket configurations. One example of such a scoring factor is a safety margin, wherein an interval or threshold may be set for how much more force the bracket configuration need to be able to withstand than the predicted peak force. Another example of a scoring factor may be bracket configuration complexity, i.e. less complex bracket configurations are favoured over more complex bracket configurations, provided that they both meet the strength requirements of the application.

According to one example embodiment, the method further comprises selecting a piece of equipment from a list of equipment and obtaining drag coefficients thereof, or inputting measurements of a piece of equipment and calculating drag coefficients thereof.

According to one example embodiment, said equipment information is indicative of an intended equipment orientation.

According to one example embodiment, the drag coefficients are calculated for a plurality of different equipment orientations.

This means that a set of drag coefficients are calculated for different equipment orientations with respect to a given wind direction. Using the drag coefficients in combination with the peak wind pressure determined, the predicted peak force applied to the equipment in each one of the plurality of directions may be determined.

The drag coefficients obtained may be calculated using CFD methods. These methods may use the geometry of the piece of equipment and a plurality of different simulated wind directions to calculate the drag coefficients thereof. Specifically, the ratios of the different equipment dimensions to each other, such as the slenderness ratio, affects the drag coefficient, as well as the rounding radii of the corners of the piece of equipment.

According to one example embodiment, the GIS information is indicative of an orography of an area surrounding the GPS position.

Alternatively, orography may be referred to as topography. In the context of the present invention, these two concepts are equivalent.

In the context of the present invention, orography is taken to mean a three-dimensional shape of the ground in an area surrounding said GPS position. In other words, the orography indicates the rise and fall of the ground, and is used when calculating the effect the landscape has on predicted peak wind pressures.

The peak wind pressure factor determination may take into account any or all of the following GIS-determined factors:
elevation above sea level at the GPS position,
distance upwind to a shoreline from the GPS position in said plurality of directions,
distance upwind to edge of an urbanized area from the GPS position in said plurality of directions,
slope of the ground at the GPS position in said plurality of directions,
for GPS positions on sloping ground, the distance from the GPS position to the start and finish of the slope in said plurality of directions,
the elevation of the intended equipment placement in relation to the crest of the slope,
the relative position of any significant orographic features such as hills, valleys, ridges, mountains, slopes, or similar to the chosen GPS position.

According to one example embodiment, the method further comprises obtaining a distance to an ocean or a sea from said directions and determining a set of second peak wind pressure factors therefrom, and wherein the peak wind pressure is further determined based on the set of second wind pressure factors.

According to one example embodiment, the method further involves obtaining information indicative of characteristics of the body of water. These characteristics may for example include surface area, greatest and smallest distance between opposite shorelines, and a geographical outline of at least a portion of the shoreline.

The closer the GPS position is to an ocean or a sea, the greater the peak wind pressure will be from that direction. The ocean or sea may alternatively be referred to as a body of water. Furthermore, information indicative of an open distance across the body of water may be obtained and used to determine the set of second peak wind pressure factors. An open distance across the body of water is the distance from one point on the coastline of the body of water to another point on the coastline, measured in a straight line from the GPS position for intended equipment placement.

According to one example embodiment, the method further comprises obtaining the location and extension of any urbanized areas surrounding the GPS position from said directions and determining a set of third peak wind pressure factors therefrom, and wherein the peak wind pressure is further determined based on the set of third wind pressure factors.

In the context of the present invention, an urbanized area is defined as an area where the peak wind pressure is significantly decreased by the surrounding buildings.

If the obtained GPS position is located inside an urbanized area, a factor accounting for the decrease in peak wind pressure from buildings in the urbanized area will be added to the sets of peak wind pressure factors. The further from the edge of an urbanized area the GPS-position, the lower the peak wind pressure will be. Also, information indicative of an average building height of the urbanized area may be obtained and used to determine the set of third peak wind pressure factors.

According to one example embodiment, the equipment information is indicative of an equipment weight, and wherein assigning a score to each one of a plurality of bracket configurations is done based on their structural properties in relation to the predicted peak force determined in combination with the equipment weight.

According to one example embodiment, the method further comprises determining offset pole dimensions based on said equipment information, wherein said offset pole dimensions is used in assigning scores to each one of said bracket configurations.

In the context of the present invention, offset pole dimensions include offset pole length, diameter, and wall thickness. An increased offset pole length to facilitate a vertical offset in equipment positioning will increase the stress put on the brackets due to an increased arm of momentum, thus requiring stronger bracket configurations. Also, an increase in either offset pole length, diameter or wall thickness increases the weight of the offset pole, thus increasing the total equipment weight. Also, an increased diameter or decreased length of the offset pole decreases its slenderness ratio, thus increasing its drag coefficient.

Thus, pieces of equipment with identical drag coefficients in identical wind conditions may require different bracket configurations based on the dimensions of the offset pole required to mount the piece of equipment to the base. Generally, the equipment information, in particular the equipment dimensions, determine the dimensions needed for the offset pole.

According to one example embodiment, the method further comprises obtaining weather information indicative of past weather conditions at the GPS position and determining a set of fourth peak wind pressure factors therefrom, and wherein the peak wind pressure is further determined based on the set of fourth wind pressure factors.

The past weather conditions may be time coded such that seasonal changes to the peak wind pressure at the GPS position may be accounted for by the set of fourth wind pressure factors. As such, the method may account for seasonal changes to the weather when determining a recommended bracket configuration for short-term installations.

According to one example embodiment, the GPS position is continuously obtained through user interaction with a graphical user interface/user input device.

This means that the user may, for example, move his or her mouse cursor (i.e. a representation of a user input device) over a map or other GIS-visualization after having provided an equipment selection and possibly also an intended elevation for the equipment, and the bracket configuration recommendation is continuously updated based on the current cursor position. Thus, a live update of recommendations is achieved as a user moves a cursor over the map.

According to one example embodiment, the method further comprises obtaining a plurality of GPS positions for potential equipment placement and generating a bracket configuration recommendation for each one of the GPS positions, and wherein the method further comprises presenting a visual representation on a graphical user interface of at least one parameter of the bracket configuration recommendation for each one of the GPS positions.

Thus, the bracket configuration recommendations for a number of different GPS positions may be presented to a user on a map or other GIS-visualization, thereby allowing the user to more quickly determine a desired placement of the piece of equipment. The presentation of bracket configuration recommendation on a map may further be based on given optimization parameters such as bracket configuration complexity, weight, expected lifetime, strength, or similar. In one example embodiment, a visual representation of a bracket configuration price for each one of said GPS positions is presented as a heat map.

According to a second aspect of the invention, a non-transitory computer-readable storage medium storing one or more programs is provided, the programs being configured to be executed by one or more processors of a control unit, the one or more programs comprising instructions for performing the method of the first aspect of the present invention.

According to a third aspect of the invention, a system is provided, the system comprising a communication unit configured to send and receive signals, and a control unit configured to: obtain a GPS position and an elevation for intended equipment placement; obtain equipment information indicative of the shape and size of the piece of equipment and calculating drag coefficients thereof; obtain GIS information associated with an area surrounding said GPS position and determining a set of first peak wind pressure factors therefrom; determine peak wind pressure from each one of a plurality of directions at the chosen elevation at said GPS position based on said set of first wind pressure factors; determine a predicted peak force which said piece of equipment is to be subjected to, based on said drag coefficients and said peak wind pressures from each one of said directions; assign a score to each one of a plurality of bracket configurations based on their structural properties in relation to the predicted peak force determined; and generate, at an output, a signal indicative of a bracket configuration recommendation based on said score.

According to one aspect of the present invention, a system is provided, said system comprising a communication unit configured to send and receive signals, and a control unit configured to perform the method of the first aspect of the present invention.

According to one example embodiment, the communication unit of the system is configured to receive input indicative of a GPS position and an elevation, equipment information, and GIS information, and to send a signal indicative of a bracket configuration recommendation generated by the control unit.

Generally, all terms used in the description are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

These and other features and advantages of the present invention will now be further clarified and described in more detail, with reference to the appended drawings showing different embodiments of a bracket configuration method and system according to the present invention.

FIG. 1 is a schematic overview of a system configured to execute the method of the present invention,

FIG. 2 is a schematic map illustrating the execution of the method after a GPS position has been obtained,

FIG. 3 is a schematic map used to illustrate the determination of different sets of peak wind pressure factors used in the method of the present invention, for a number of different GPS positions,

FIG. 4 is a schematic map used to illustrate the generation of bracket configuration recommendations for different GPS positions,

FIG. 5 is a schematic map used to illustrate one embodiment of the present invention, in which the GPS position is continuously obtained through user interaction with a graphical user interface/user input device,

FIG. 6 is a schematic overview of steps of the method of the present invention.

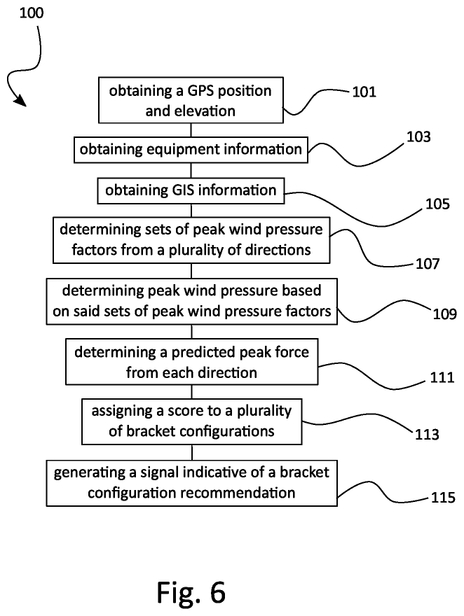

### DETAILED DESCRIPTION OF EMBODIMENTS

In the following detailed description, some embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

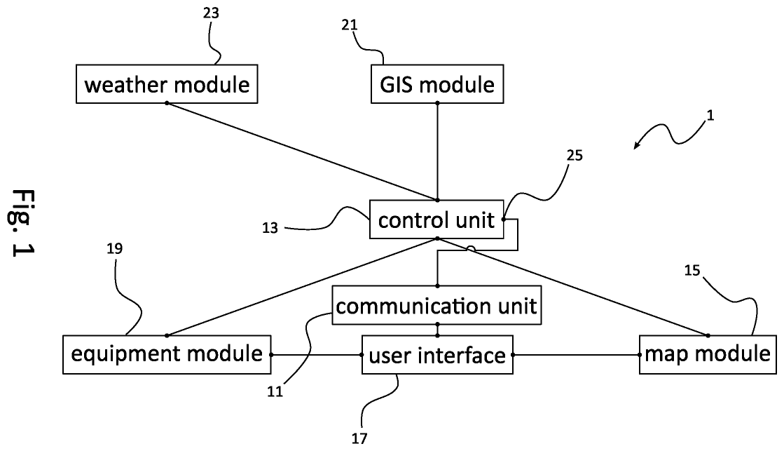

FIG. 1 is a schematic overview of a system 1 configured to execute the method 100 of the present invention. The system 1 comprises a communication unit 11 configured to send and receive signals, and a control unit 13 configured to perform a method 100 for bracket configuration recommendation 200 for a user-selected piece of equipment used for signal transmission.

Specifically, the control unit 13 is configured to obtain a GPS position 101 and an elevation for intended equipment placement from a map module 15, with which a user may interact through a user interface 17. The GPS position is obtained 101 by having the user select a position on a map, and input an intended elevation for equipment placement into the user interface 17.

Alternatively, the GPS position may be continuously obtained 101 through user interaction with the user interface 17. This means that the user may, for example, move his or her cursor (i.e. a representation of a user input device) over a map or other GIS-visualization after having provided an equipment selection and possibly also an intended elevation for the equipment, and the bracket configuration recommendation 200 is continuously updated and presented based on the current cursor position. Thus, a live update of recommendations is achieved as a user moves a cursor over the map.

The control unit 13 is further configured to obtain equipment information 103 indicative of at least the shape and size of the piece of equipment and to calculate drag coefficients thereof. The equipment information is obtained 103 by having a user select a piece of equipment from a list, and having an equipment module 19 retrieve information about this piece of equipment from a database. Alternatively, the user may input key measurements and characteristics of the piece of equipment into the equipment module 19, which then obtains equipment information 103 based on these input parameters.

The equipment information obtained also indicates an intended equipment orientation relative to the base structure and/or relative to the ground. The intended equipment orientation may be obtained through a user interacting with the map module 15 and/or the equipment module 19 through the user interface 17. Once the equipment information is obtained 103, the drag coefficients are then calculated for a plurality of different wind directions and/or equipment orientations.

The drag coefficients may be calculated by the equipment module 19 or the control unit 13, using CFD methods. This ensures accurate prediction of peak loads on the equipment to be mounted. CFD methods use the geometry of the piece of equipment and a plurality of different simulated wind directions to calculate the drag coefficients. Specifically, the ratios of the different equipment dimensions to each other, such as the slenderness ratio, as well as the rounding radii of the corners of the piece of equipment are used in determining the drag coefficients.

Alternatively, the control unit 13 may be configured to obtain information indicative of a selected piece of equipment from a list of equipment and to obtain drag coefficients therefrom.

The equipment information obtained also indicates an equipment weight, which is used when determining the predicted peak load to be supported by the bracket configuration.

The drag coefficients are used in calculating a predicted peak load that the bracket configuration need to be able to bear. Since the peak wind pressure will differ from different directions, and since the drag coefficient of the piece of equipment differs for different directions, a plurality of predicted peak loads is determined, for a plurality of different directions. The recommended bracket configuration thus need to fulfill the structural requirements from each one of said directions. In order to predict the peak wind pressure from the plurality of different directions, a number of sets of peak wind pressure factors are determined 107, as described below.

The control unit 13 is further configured to obtain GIS information 105 from a GIS module 21, wherein the GIS information is associated with an area surrounding the GPS position obtained. The GIS information is, for example, indicative of an orography of an area surrounding the GPS position, which is used to determine 107 a set of first peak wind pressure factors. By identifying significant orographic features in an area surrounding the GPS position obtained, the method 100 may determine what effect these features will have on the peak wind pressure experienced by the piece of equipment.

The control unit 13 is further configured to obtain, from the map module 15 or the GIS module 21, a distance from the GPS position to an ocean or a sea, henceforth referred to as a body of water, from each one of the plurality of directions used in the method 100. The control unit 13 is also configured to obtain information indicative of characteristics of the body of water, and to determine 107 a set of second peak wind pressure factors therefrom.

The closer the GPS position is to a body of water, the greater the peak wind pressure will be from that direction. Furthermore, information indicative of an open distance across the body of water may be obtained and used to determine the set of second peak wind pressure factors. An open distance across the body of water is the distance from one point on the coastline of the body of water to another point on the coastline, measured in a straight line from the GPS position for intended equipment placement. The characteristics obtained may for example include surface area, greatest and smallest distance between opposite shorelines, and a geographical outline of at least a portion of the shoreline.

Similarly, the control unit 13 is configured to obtain the location and extension of any urbanized areas surrounding the GPS position obtained and to determine 107 a set of third peak wind pressure factors therefrom. Also, the control unit 13 is configured to obtain information indicative of an average building height of the urbanized area, wherein this information is also used in determining 107 the set of third peak wind pressure factors.

If the obtained GPS position is located inside an urbanized area, a factor accounting for the decrease in peak wind pressure from buildings in the urbanized area will be added to the sets of peak wind pressure factors. The further from the edge of an urbanized area the GPS-position, the lower the peak wind pressure will be.

Finally, the control unit 13 is configured to obtain weather information from a weather module 23, wherein the weather information is indicative of past weather conditions at the GPS position and is used in determining 107 a set of fourth peak wind pressure factors. The peak wind pressure is further determined 109 based on the set of fourth wind pressure factors.

The past weather conditions may be time coded such that seasonal changes to the peak wind pressure at the GPS position may be accounted for by the set of fourth wind pressure factors. As such, the method 100 may account for seasonal changes to the weather when determining a recommended bracket configuration for short-term installations.

Using the sets of wind pressure factors determined, the control unit 13 then determines a predicted peak wind pressure 109 from each one of the plurality of directions at the chosen elevation at the GPS position.

Then, the control unit 13 is configured to determine a predicted peak force 111 which the piece of equipment is to be subjected to, based on the drag coefficients and the peak wind pressures from each one of said directions.

This predicted peak force is then used by the control unit 13 to assign a score 113 to each one of a plurality of bracket configurations based on their structural properties in relation to the predicted peak force determined.

The scoring assigns a score 113 to each bracket configuration, wherein the score is indicative of the relationship between the strength of the bracket configuration and the peak force predicted that the piece of equipment will be subjected to for each one of said directions.

The control unit 13 then generates 115, at an output 25 thereof, a signal indicative of a bracket configuration recommendation 200 based on the scores assigned.

Finally, the method 100 comprises using the communication unit 11 to obtain the signal generated at the output 25 of the control unit 13, and communicate the bracket configuration recommendation 200 thus indicated to a user, e.g. by means of the user interface 17.

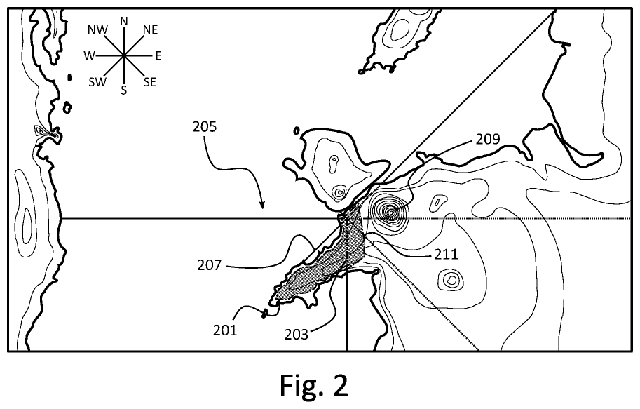

FIG. 2 is a schematic map illustrating the execution of the method 100 after a GPS position has been obtained 101. Shown therein is a graphical representation of a map, obtained through the map module 15 and presented to the user through the user interface 17. The map comprises symbols indicative of orography, such as contour lines and coastal lines, and urbanized areas 201 indicated by markings. In the use scenario illustrated in FIG. 2, a GPS position has been selected, from which the distance 203 to a body of water 205, and the distance 207 across, is determined from six different directions, and from which significant orography 209 in the surrounding area is detected. Additionally, since the selected GPS position lies within an urbanized area 201, the distance 211 to the edge of the urbanized area is also determined in the different directions. Based on this, and based on information obtained as per the description of the system in relation to FIG. 1, a number of sets of peak wind pressure factors are determined 107. An example of such peak wind pressure factors is given in the tables.

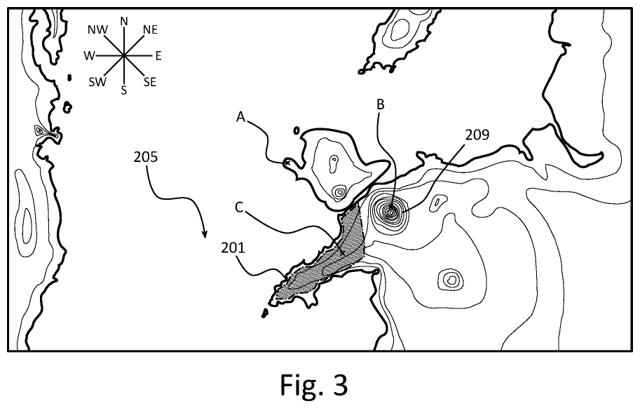

FIG. 3 is a schematic map used to illustrate the determination 107 of different sets of peak wind pressure factors used in the method 100 of the present invention, for a number of different GPS positions. Here, three different GPS positions A, B, and C, are used to illustrate the determination 107 of the sets of peak wind pressure factors.

A non-exhaustive list of factors affecting the predicted peak wind pressures from different directions at the different GPS positions are given below.

For GPS position A, the surrounding open water does not cause the predicted peak wind pressure to decrease in any direction but east, where a landmass is located.

For GPS position B, there is significant orography in the shape of a height located just south of the position. This causes the predicted peak wind pressure from the south to be lower, while the slope causes the predicted peak wind pressure from the north to increase. How orography affects predicted peak wind pressure depends on a number of factors, among which are intended height of equipment placement, slope of orographic feature, distance to start and end of orographic features, etc.

For GPS position C, the distance to the edge of the urbanized area decreases the predicted peak wind pressure from all directions to different degrees, depending on how far from the edge in said direction the position is.

Below are three tables illustrating example sets of peak wind pressure factors for GPS positions A, B, and C.

GPS position A

| Factor | | North- | | South- | | South- | | North- |
|---|---|---|---|---|---|---|---|---|
| type | North | east | East | east | South | west | West | west |
| Orography | 1 | 1 | 0.8 | 1 | 1 | 1 | 1 | 1 |
| Distance to | 1.5 | 1 | 1 | 1 | 1.3 | 1.5 | 1.4 | 1.5 |
| water | | | | | | | | |
| Distance to | — | — | — | — | — | — | — | — |
| city border | | | | | | | | |
| Weather | 1.1 | 0.9 | 0.9 | 0.8 | 1 | 1.2 | 1.3 | 1.3 |
| data | | | | | | | | |
| Season - | 0.8 | 0.9 | 1.3 | 1.4 | 1.2 | 1 | 0.8 | 0.4 |
| winter | | | | | | | | |
| Season - | 0.4 | 0.8 | 0.9 | 1.3 | 1.4 | 1.2 | 1 | 0.8 |
| spring | | | | | | | | |
| Season - | 0.8 | 0.4 | 0.8 | 0.9 | 1.3 | 1.4 | 1.2 | 1 |
| summer | | | | | | | | |
| Season - | 1 | 0.8 | 0.4 | 0.8 | 0.9 | 1.3 | 1.4 | 1.2 |
| autumn | | | | | | | | |

GPS position B

| Factor | | North- | | South- | | South- | | North- |
|---|---|---|---|---|---|---|---|---|
| type | North | east | East | east | South | west | West | west |
| Orography | 1.3 | 1 | 1 | 1 | 0.6 | 1 | 1 | 1 |
| Distance to | 1.1 | 1 | 1 | 1 | 1 | 1.1 | 1.2 | 1.1 |
| water | | | | | | | | |
| Distance to | — | — | — | — | — | — | — | — |
| city border | | | | | | | | |
| Weather | 1.1 | 0.9 | 0.9 | 0.8 | 1 | 1.2 | 1.3 | 1.3 |
| data | | | | | | | | |
| Season - | 0.8 | 0.9 | 1.3 | 1.4 | 1.2 | 1 | 0.8 | 0.4 |
| winter | | | | | | | | |
| Season - | 0.4 | 0.8 | 0.9 | 1.3 | 1.4 | 1.2 | 1 | 0.8 |
| spring | | | | | | | | |
| Season - | 0.8 | 0.4 | 0.8 | 0.9 | 1.3 | 1.4 | 1.2 | 1 |
| summer | | | | | | | | |
| Season - | 1 | 0.8 | 0.4 | 0.8 | 0.9 | 1.3 | 1.4 | 1.2 |
| autumn | | | | | | | | |

GPS position C

| Factor | | North- | | South- | | South- | | North- |
|---|---|---|---|---|---|---|---|---|
| type | North | east | East | east | South | west | West | west |
| Orography | 1 | 1 | 1 | 1 | 1 | 1 | 1 | 1 |
| Distance to | 1 | 1 | 1 | 1 | 1.3 | 1.1 | 1.2 | 1.4 |
| water | | | | | | | | |
| Distance to | 0.7 | 0.8 | 0.9 | 0.9 | 0.9 | 0.6 | 0.9 | 0.9 |
| city border | | | | | | | | |
| Weather | 1.1 | 0.9 | 0.9 | 0.8 | 1 | 1.2 | 1.3 | 1.3 |
| data | | | | | | | | |
| Season - | 0.8 | 0.9 | 1.3 | 1.4 | 1.2 | 1 | 0.8 | 0.4 |
| winter | | | | | | | | |
| Season - | 0.4 | 0.8 | 0.9 | 1.3 | 1.4 | 1.2 | 1 | 0.8 |
| spring | | | | | | | | |
| Season - | 0.8 | 0.4 | 0.8 | 0.9 | 1.3 | 1.4 | 1.2 | 1 |
| summer | | | | | | | | |
| Season - | 1 | 0.8 | 0.4 | 0.8 | 0.9 | 1.3 | 1.4 | 1.2 |
| autumn | | | | | | | | |

Using these peak wind pressure factors in combination with the drag coefficients for a piece of equipment, taking into account the intended orientation of the piece of equipment, the predicted peak force applied to the piece of equipment may be determined 111 and used in generating 115 a recommendation on a bracket configuration to use for that piece of equipment at that GPS position.

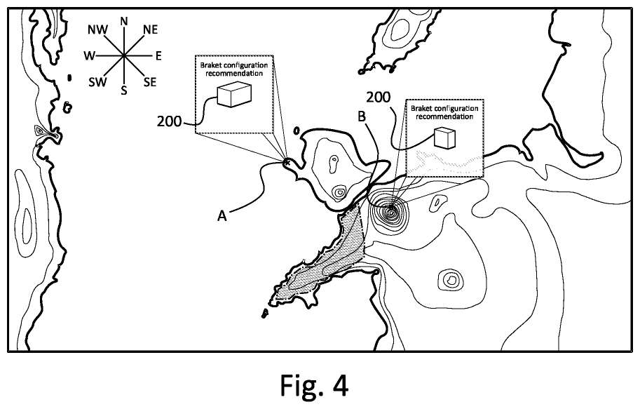

FIG. 4 is a schematic map used to illustrate the generation 115 of bracket configuration recommendations 200 for a plurality of different GPS positions. Here, equipment information has been obtained 103, along with GIS information and weather information for an area selected by the user. The method 100 may, according to one example embodiment of the present invention, use the equipment information, the GIS information and the weather information and generate 115 recommendations on bracket configurations for a plurality of different GPS positions chosen in the area selected by the user. The GPS position for which recommendations are generated 115 may be selected using information indicative of positions suitable for said equipment placement. Illustrated herein is the generation and presentation of two different bracket configuration recommendations 200, for a respective GPS position in the area selected by the user. Additionally or alternatively, a bracket configuration recommendation 200 may be generated for each one of a plurality of GPS positions within the area chosen by the user, and a visual representation may be presented on the user interface 17 of at least one parameter of the bracket configuration recommendation 200 generated for each one of the GPS positions.

Thus, the bracket configuration recommendations 200 for a number of different GPS positions may be presented to a user on a map or other GIS-visualization, thereby allowing the user to more quickly determine a desired placement of the piece of equipment. The presentation of bracket configuration recommendation 200 on a map may further be based on given optimization parameters such as bracket configuration complexity, weight, expected lifetime, strength, or similar. In one example embodiment, a visual representation of a bracket configuration parameter, e.g. complexity, weight, price, or similar, for each one of said GPS positions is presented as a heat map.

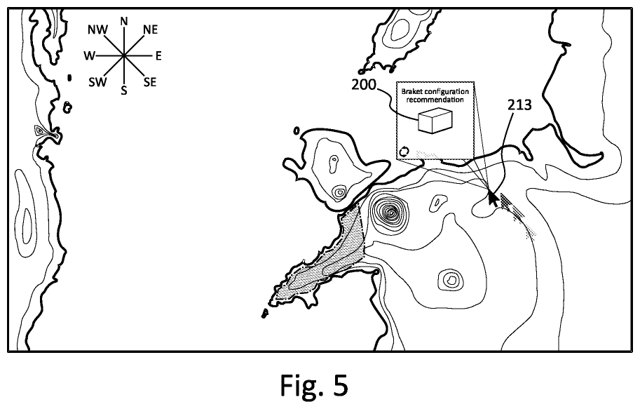

FIG. 5 is a schematic map used to illustrate one embodiment of the present invention, in which the GPS position is continuously obtained 101 through user interaction with a user interface 17. In this embodiment a plurality of GPS positions for potential equipment placement are continuously obtained 101 through user interaction with the user interface 17. This means that the user may, as illustrated, move his or her cursor 213 over a map or other GIS-visualization after having provided an equipment selection and possibly also an intended elevation for the equipment, and the bracket configuration recommendation 200 is continuously updated based on the current cursor 213 position. Thus, a live update of bracket configuration recommendations 200 is achieved as a user moves a cursor 213 over the map.

The person skilled in the art realizes that the present invention by no means is limited to the embodiments described above. The features of the described embodiments may be combined in different ways, and many modifications and variations are possible within the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements.

1. A computer implemented method for bracket configuration for a user-selected piece of equipment used for sending or receiving electromagnetic radiation, wherein said piece of equipment is to be subjected to wind pressure, said method comprising:
obtaining a GPS position and an elevation for intended equipment placement by means of a user interacting with a graphical user interface of a computer implemented map module;
obtaining equipment information indicative of the shape and size of the piece of equipment and calculating drag coefficients thereof;
obtaining GIS information associated with an area surrounding said GPS position and determining a set of first peak wind pressure factors therefrom;
determining peak wind pressure from each one of a plurality of directions at the chosen elevation at said GPS position based on said set of first peak wind pressure factors;
determining a predicted peak force which said piece of equipment is to be subjected to, based on said drag coefficients and said peak wind pressures from each one of said directions;
assigning a score to each one of a plurality of bracket configurations based on their structural properties in relation to the predicted peak force determined; and
generating, at an output, a signal indicative of a bracket configuration recommendation based on said score.

2. The method of claim 1, wherein the drag coefficients are calculated for a plurality of different equipment orientations.

3. The method of claim 1, wherein said GIS information is indicative of an orography of an area surrounding said GPS position.

4. The method of claim 1, wherein said method further comprises obtaining a distance to an ocean or a sea from said directions and determining a set of second peak wind pressure factors therefrom, and wherein said peak wind pressure is further determined based on said set of second peak wind pressure factors.

5. The method of claim 1, wherein said method-further comprises obtaining the location and extension of any urbanized areas surrounding said GPS position from said directions and determining a set of third peak wind pressure factors therefrom, and wherein said peak wind pressure is further determined based on said set of third peak wind pressure factors.

6. The method of claim 1, wherein said equipment information is indicative of an equipment weight, and wherein assigning a score to each one of a plurality of bracket configurations is done based on their structural properties in relation to the predicted peak force determined in combination with said equipment weight.

7. The method of claim 1, further comprising determining offset pole dimensions based on said equipment information, and wherein said offset pole dimensions is used in assigning a score to each one of said bracket configurations.

8. The method of claim 1, wherein said method-further comprises obtaining weather information indicative of past weather conditions at said GPS position and determining a set of fourth peak wind pressure factors therefrom, and wherein said peak wind pressure is further determined based on said set of fourth peak wind pressure factors.

9. The method of claim 1, wherein said GPS position is continuously obtained through user interaction with a graphical user interface or user input device.

10. The method of claim 1, further comprising obtaining a plurality of GPS positions for potential equipment placement and generating a bracket configuration recommendation for each one of said GPS positions, and wherein said method further comprises presenting a visual representation on a graphical user interface of at least one parameter of said bracket configuration recommendation for each one of said GPS positions.

11. A non-transitory computer-readable storage medium storing one or more programs configured to be executed by one or more processors of a control unit, the one or more programs comprising instructions for performing the method according to claim 1.

12. A system comprising a communication unit configured to send and receive signals, and a control unit configured to:
obtain a GPS position and an elevation for intended equipment placement;
obtain equipment information indicative of the shape and size of the piece of equipment and calculate drag coefficients thereof;
obtain GIS information associated with an area surrounding said GPS position and determine a set of first peak wind pressure factors therefrom;
determine peak wind pressure from each one of a plurality of directions at the chosen elevation at said GPS position based on said set of first peak wind pressure factors;
determine a predicted peak force which said piece of equipment is to be subjected to, based on said drag coefficients and said peak wind pressures from each one of said directions;
assign a score to each one of a plurality of bracket configurations based on their structural properties in relation to the predicted peak force determined; and
generate, at an output, a signal indicative of a bracket configuration recommendation based on said score.
